(19) United States
(12) Patent Application Publication
(10) Pub. No.: US 2009/0231284 A1
(43) Pub. Date: Sep. 17, 2009

(54) Portable Electronic Device and Program Image Selecting Method

(75) Inventor: JUNG CHI LAI, Taoyuan County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Darfon Electronics Corp.

(21) Appl. No.: 12/401,282

(22) Filed: Mar. 10, 2009

(30) Foreign Application Priority Data
Mar. 14, 2008 (TW) 097109032

(51) Int. Cl. G06F 3/02

(52) U.S. Cl. 345/172

(57) ABSTRACT

The invention provides a portable electronic device comprising a display unit and an input module. The display unit is for displaying frames. The input module is coupled to the display unit and includes a control unit and a hotkey. The hotkey is for controlling the display unit to display or close a sub-window in the frames, therein the sub-window includes a selecting section and at least one program image. When the display unit displays the sub-window in the frame, the control unit could be operated by a user to control a first program image of the program images to overlap the selecting section.

### BACKGROUND OF THE INVENTION

1. Field of the Invention

The present invention relates generally to a portable electronic device and a program image selecting method, and more particularly, the present invention relates to a portable electronic device which is capable of quickly selecting a program image and a program image selecting method.

2. Description of the Prior Art

Notebook computer has been becoming more and more popularized. In order to develop its characters such as high mobility and space-saving, notebook computers tend to be of light weight, thin thickness, and small volume. Owing to the restriction of the volume, notebook computers are designed to be more delicate than desktop computers.

There was no pointing device in notebook computers in the early days. However, as the development of windows software, various types of pointing devices (e.g. trackballs, track points, track pads, track boards, touch pads, pop up mice, touch pens, etc) configured to notebook computers have gradually appeared on the market to substitute for difficultly portable desk mice. Among those pointing devices mentioned above, the touch pad is the most popular and practical pointing device at present. The touch pad, a flat board disposed in front of a keyboard, is capable of sensing a use's movement thereon so as to direct a cursor's movement. Thereby, the cursor could be moved to select the required program image to perform the program.

However, when there are several programs installed in the computer system and only one of them is required to be performed, users have to carefully search for the images representing the programs, selects the image representing the program which is required to be performed and then clicks the image to perform the program. Thus, time is wasted during the process of searching for the images so that the user's working schedule is affected. On the other hand, when the user is processing other programs, he has to suspend the present proceeding program to search for the required program images instead of processing the present program and the searching simultaneously.

In the prior art, many operating systems are provided with hot bar. Users could directly move the cursor to the hot bar and select a program image on the hot bar to perform a program corresponding to the program image instead of suspending the processing program. However, when the user is processing plenty of programs, it could waste the user's time to move the cursor and then affect the user's working schedule.

### SUMMARY OF THE INVENTION

Accordingly, an aspect of the present invention is to provide a portable electronic device for quickly selecting the required program image so as to perform the corresponding program relative to the program image; therefore the time for selecting the program image could be effectively saved and the problems mentioned above is thus solved.

According to an embodiment, the portable electronic device of the invention includes a display unit and an input module. The display unit is for displaying frames. The input module is coupled to the display unit and includes a control unit and a hotkey. The hotkey is for controlling the display unit to display a sub-window in the frame. Moreover, the hotkey could be used for controlling the display unit to close a sub-window in the frame as well.

In the embodiment, the sub-window displayed by the display unit includes a selecting section and at least one program image. When the display unit displays the sub-window in the frame, the control unit could be operated by a user to control one of the program images to overlap the selecting section. In the embodiment, the program image overlapping the selecting section is the required program image.

In the embodiment, the user uses a touch unit to slide along a direction on an operation surface of the control unit to control the program image to move, so as to make the required program image to overlap the selecting section. Practically, the user could control the selecting section to move to overlap the required program image by means of the control unit as well.

Another aspect of the invention is to provide a program image selecting method for quickly selecting a required program image by means of cooperating with a control unit and a hotkey of a portable electronic device, and further performing the program corresponding to the program image.

According to an embodiment, the program image selecting method of the invention includes the following steps. Firstly, a sub-window is displayed in a frame by a display unit of the portable electronic device when a user presses the hotkey, therein the sub-window includes a selecting section and several program images. Subsequently, the control unit is operated by the user to control one of the program images to overlap the selecting section. In the embodiment, the program image overlapping the selecting section is the required program image.

In the embodiment, the user could use a touch unit to slide along a direction on an operation surface of the control unit to control the program image to move, so as to make the required program image to overlap the selecting section. Practically, the user could control the selecting section to move to overlap the required program image by means of the control unit as well.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 illustrates a portable electronic device according to an embodiment of the invention.

FIG. 2A illustrates a display unit in FIG. 1 displaying a sub-window in a frame.

FIG. 2B illustrates the program images in FIG. 2 arranged in a circle in the sub-window.

FIG. 3 is a flow chart demonstrating a program image selecting method according to an embodiment of the invention.

FIG. 4 is a flow chart demonstrating a program image selecting method according to another embodiment of the invention.

FIG. 5 is a flow chart demonstrating a program image selecting method according to another embodiment of the invention.

### DETAILED DESCRIPTION OF THE INVENTION

The present invention provides a portable electronic device and a program image selecting method. The portable electronic device and the program image selecting method are capable of selecting the required program image quickly.

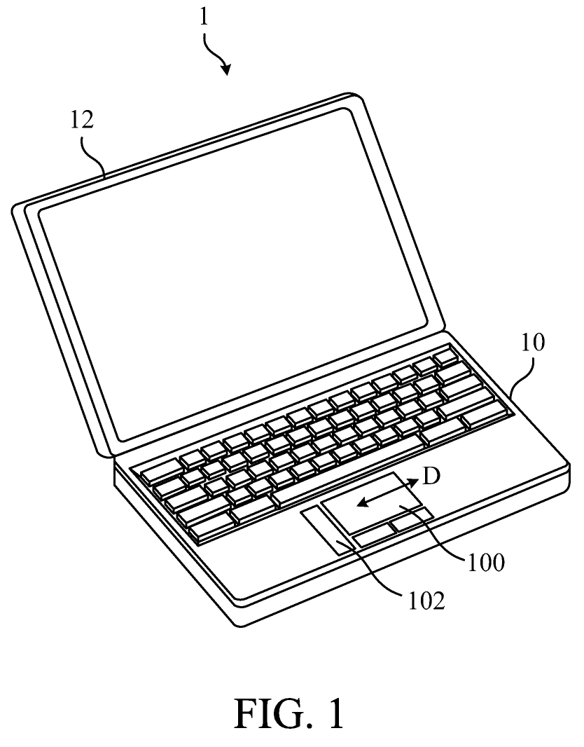

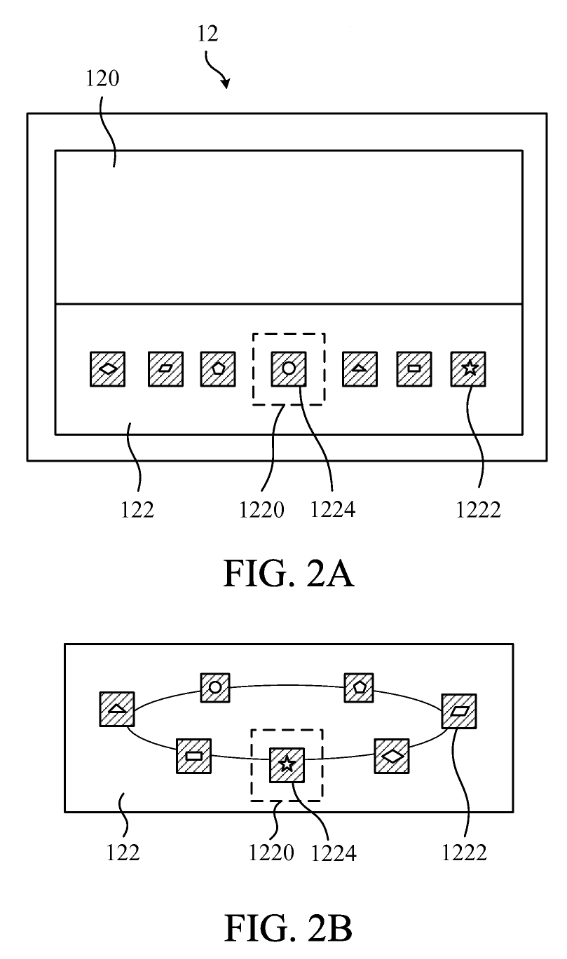

Please refer to FIG. 1, FIG. 2A and FIG. 2B. FIG. 1 illustrates the portable electronic device 1 according to an embodiment of the invention. FIG. 2A illustrates a display unit 12 in FIG. 1 displaying a sub-window 122 in a frame 120. FIG. 2B illustrates program images 1222 in FIG. 2 arranged in a circle in the sub-window 122. In the embodiment, the portable electronic device 1 is a notebook computer. However, in practical applications, the portable electronic device 1 could also be, but not limited to, a mobile phone, a PDA or other appropriate electronic apparatuses.

Furthermore, as illustrated in FIG. 1, the portable electronic device 1 includes an input module 10 and a display unit 12. The display unit 12 is for displaying frames. The input module 10 is coupled to the display unit 12 and includes a control unit 100 and a hotkey 102. Generally, the user could control the frame and a cursor in the frame by means of an input module (e.g. keyboard) and the control unit. In the embodiment, the control unit 100 is a touch panel of a notebook computer. However, in practical applications, the control unit 100 could be an input device such as a mouse, a keyboard, a touch panel, a trace panel or a plotting board, etc.

In the embodiment, pressing the hotkey 102 could control the display unit 12 to display a sub-window 122. Please notice that the position of the hotkey 102 could be disposed in an appropriate position on the input module 10 in practical applications, which depends on the requirement of the user or the designer. As illustrated in FIG. 2, when the hotkey 102 in FIG. 1 is pressed, the display unit 12 displays the sub-window 122 in the frame 120. Please notice that the position of the sub-window 122 in the embodiment is displayed on the lower half of the frame 120, but the sub-window 122 could be also displayed on any position of the frame 120 in practical applications, depending on the requirement of the user or the designer instead of being limited to the embodiment. Moreover, the size of the sub-window 122 could be adjusted as the requirements in practical applications.

As illustrated in FIG. 2A, the sub-window 122 in the embodiment comprises a selecting section 1220 and at least one program image 1222. Practically, the program image 1222 could be, but not limited to, a shortcut of a program. In other wards, each program image 1222 could represent a corresponding program. When one of the program images 1222 is selected, the program relative to the selected program image 1222 could be performed. For example, when one of the program images 1222 is a shortcut of word software, performing the program image 1222 is performing the word software; thus the operations of word editing could be processed. Practically, the number of the program images and their corresponding programs could be determined by the designers, or substituted by users themselves, so that the purpose of customization is thus achieved.

The program images 1222 could be arranged according to a basis in the sub-window 122, such as arranged in a row in the embodiment. Practically, the way of arrangement of the program images 1222 could depend on the requirement of the designers or users. For example, when a user is not satisfied with the program images 1222 arranged in a row, the program images 1222 could be arranged in a circle by means of a menu or an instruction, as shown in FIG. 2B. In addition, the sequence, the size or the visual angle of the program images 1222 could be adjusted by users in practical applications. Moreover, the backdrop color or the backdrop image of the sub-window 122 could also be adjusted.

When the display unit 12 displays the sub-window 122 in the frame 120, the control unit 100 could be operated by a user to control one of the program images 1222, namely, the first program image 1224, to overlap the selecting section 1220. Practically, the first program image 1224 is the required program image. Moreover, the control unit 100 could further control the portable electronic device 1 to perform the program relative to the first program image 1224.

In the embodiment, users could use a touch unit (not shown in the figure) to slide substantially along a direction D on an operation surface of the control unit 100 to control the first program image 1224 to overlap the selecting section 1220. For example, users could use their finger (the touch unit) to slide left and right on the touch panel (the control unit 100) to control the program images 1222 arranged in a row to move to the selecting section 1220 in turn. When users stop sliding their fingers, the program image 1222 overlapping the selecting section 1220 is the first program image 1224. Practically, the touch unit could be users' fingers or other appropriate hardware such as touch pen, etc. Otherwise, depending on the difference of the control units 100, users could process different operation to control the first program image 1224 to overlap the selecting section 1220. For example, if the control unit 100 is a keyboard, users could control the movement of the selecting section 1220 or the program image 1222 by means of the direction keys of the keyboard so as to make the first program image 1224 to overlap the selecting section 1220.

Practically, the selecting section 1220 could be a visible section or an invisible section. For example, when a user's finger slides on the control unit 100, the program images 122 could be magnified or glittered in turn as a way of reminder to remind users that the invisible section 1220 is overlapping the program image 1222.

Practically, one of the selecting section 1220 and the program image 1222 could be moved according to a user's operation on the control unit 100. For example, when a user uses a touch unit to slide substantially along a direction D on an operation surface of the control unit 100, the program images 1222 are controlled by the control unit 100 to move in turn to the selecting section 1220 which is at a fixed position and overlap the selecting section 1220. On the other hand, when a user uses a touch unit to slide substantially along a direction D on an operation surface of the control unit 100, the selecting section 1220 could be controlled by the control unit 100 to move to the program images 1222 which are in fixed positions in turn and overlap one of the program images 1222.

Moreover, in practical applications, the movements of the selecting section 1220 or the program images 1222 could be phasic. In other words, when the touch unit stops sliding on the operation surface of the control unit 100 and the selecting section 1220 does not overlap one of the program images 1222, the selecting section 1220 or the program images 1222 could keep moving along the same direction until the selecting section 1220 overlaps one of the program images 1222.

To summarize, when users are processing other programs on the portable electronic device, a sub-window could be displayed in the frame of a display unit by means of a hotkey. The sub-window includes a selecting section and program images. Subsequently, users could select the program image in turn by means of the control unit. Therefore the users could quickly select or perform other programs while other programs are being processed.

According to another embodiment, the difference between the present embodiment and the previous embodiment is that when the selecting section overlaps one of the first program images, the display unit further displays a sub-menu frame relative to the first program image. For example, if a program image represents a shortcut of a folder, when the control unit controls the program image to overlap the selecting section, the display unit further displays the sub-menu frame to reveal the shortcuts of the programs included in the folders. In other words, when the hotkey controls the display unit to display the sub-window, the first program image could be selected from the sub-window by means of the control unit; when the display unit displays the sub-menu frame relative to the first program image, a second program image could be selected from the sub-menu frame by means of the control unit.

Furthermore, according to another embodiment, when the display unit displays the sub-window, the display unit could be controlled to close the sub-window by means of pressing the hotkey. According to another embodiment, when the control unit controls the portable electronic device to perform the program relative to the first program image, the display unit could close the sub-window automatically and return to the original frame to process the program relative to the first program image or other programs.

In the embodiment mentioned above, when the display unit displays the sub-window, the control unit is only in charge of the selection of the program images in the sub-window. However, the control unit, practically, could also control the frame (e.g. the cursor in the frame) and the sub-window to achieve the effect of simultaneous operation. On the other hand, the portable electronic device could be further coupled to an external input unit to control the cursor in the frame. For example, a notebook computer could be externally coupled to a mouse. Thereby, the cursor in the frame could be controlled by means of the external input unit to quickly select the required program instead of suspending the present processing program and the time for selecting the program image could be saved.

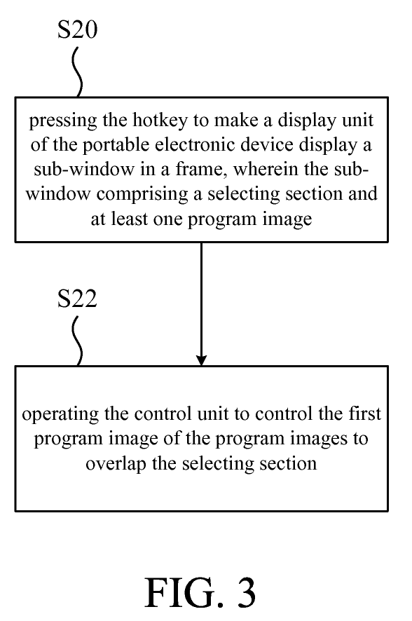

Please refer to FIG. 3. FIG. 3 is a flow chart demonstrating a program image selecting method according to an embodiment of the invention. As illustrated in FIG. 3, the program image selecting method of the invention could quickly select a required program image by means of cooperating with a control unit and a hotkey of a portable electronic device. The method includes the following steps. Firstly, in the step S20, a sub-window is displayed in a frame by a display unit of the portable electronic device when a user presses the hotkey, therein the sub-window includes a selecting section and several program images. Subsequently, in the step S22, the control unit is operated by the user to control one of the program images, i.e. the first program image, to overlap the selecting section. In the embodiment, the first program image is the program image the user wants to select.

Practically, the method of performing the step S22 could use a touch unit to slide along a direction on an operation surface of the control unit to control the first program image to move to the selecting section and overlap the selecting section. On the other hand, the touch unit could also slide along a direction on the operation surface of the control unit to control the selecting section to move to overlap the first program image.

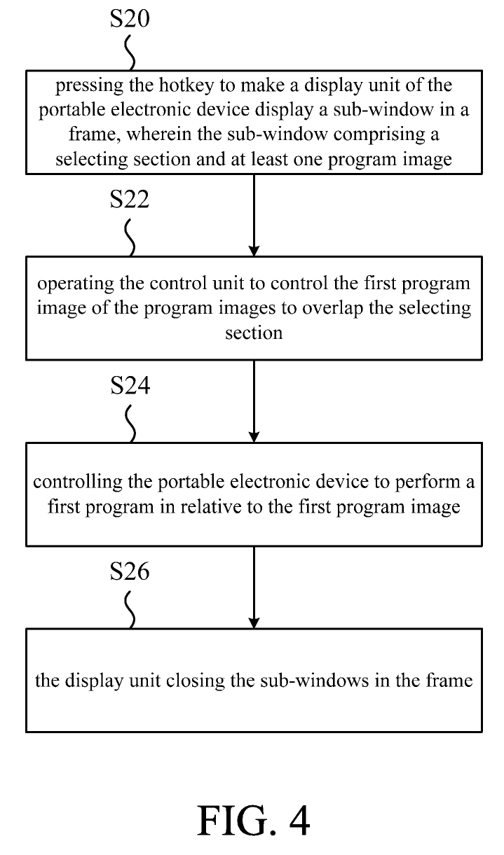

Please refer to FIG. 4. FIG. 4 is a flow chart demonstrating a program image selecting method according to another embodiment of the invention. As illustrated in FIG. 4, the difference between the present embodiment and the previous embodiment is that the program image selecting method in the embodiment further includes the following steps of controlling the portable electronic device to perform a first program relative to the first program image in step S24, and the display unit closing the sub-windows in the frame in step S26. Practically, in step S24, the portable electronic device could be controlled to perform the first program by means of the control unit. For example, after the control unit controls the selecting section and the first program image to overlap, the portable electronic device could be controlled to perform the first program relative to the first program image by means of the touch unit clicking the operation surface of the control unit.

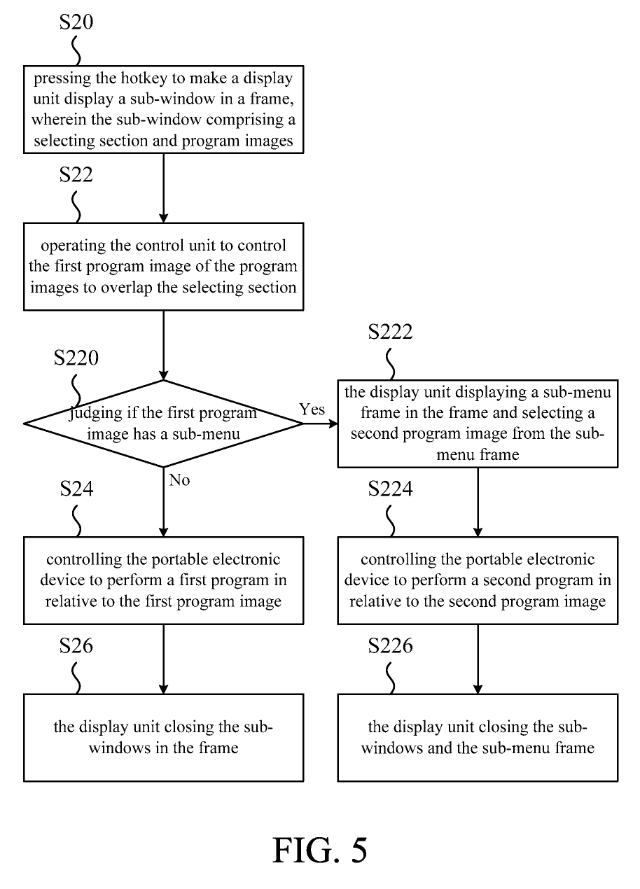

Please refer to FIG. 5. FIG. 5 is a flow chart demonstrating a program image selecting method according to another embodiment of the invention. As illustrated in FIG. 5, the difference between the present embodiment and the previous embodiment is that the program image selecting method in the embodiment further includes the following steps of judging if the first program image has a sub-menu in the step S220. If yes, a sub-menu frame is displayed in the frame by the display unit in the step S222 and a second program image is selected from the sub-menu frame. Subsequently, the step S224 is performed to control the portable electronic device to perform a second program relative to the second program image. Then the step S226 is performed to control the display unit to close the sub-windows and the sub-menu frame. If the judging result in the step S220 is no, the program image selecting method performs the step S24. Please notice that in practical applications, the second program image could be selected from the sub-menu frame by means of the control unit in the step S222.

Furthermore, in practical applications, while the display unit is controlled to display the sub-window in the program image selecting method of the previous embodiment, the hotkey could be pressed to control the display unit to close the sub-window. Moreover, in practical applications, while the display unit is controlled to display the sub-menu frame in the program image selecting method of the previous embodiment, the hotkey could be pressed to control the display unit to close the sub-menu frame.

Compared to the prior art, the portable electronic device and the program image selecting method of the invention enable users to quickly select the required program image and perform the program relative to the program image with the portable electronic device. By means of the customization program images in the menu-window, users could search for the required program image from the customization program images without suspending the present processing program. Moreover, the program images or the selecting section in the frame could be moved by means of the control unit to reach the purpose of selecting the required program image without controlling the cursor. To summarize, the portable electronic device and the program image selecting method of the invention could save the time for searching and selecting the program image.

Although the present invention has been illustrated and described with reference to the preferred embodiment thereof, it should be understood that it is in no way limited to the details of such embodiment but is capable of numerous modifications within the scope of the appended claims.

What is claimed is:

1. A portable electronic device comprising:
a display unit for displaying a frame; and
a input module coupled to the display unit, the input module comprising:
a control unit; and
a hotkey for controlling the display unit to display or close a sub-window in the frame, the sub-window comprising a selecting section and at least one program image;
wherein when the display unit displays the sub-window in the frame, the control unit could be operated by a user to control a first program image of the program images to overlap the selecting section.

2. The portable electronic device of claim 1, wherein the user uses a touch unit to slide along a direction on an operation surface of the control unit to control the first program image to move to the selecting section.

3. The portable electronic device of claim 1, wherein the user uses a touch unit to slide along a direction on the operation surface of the control unit to control the selecting section to move to the first program image.

4. The portable electronic device of claim 1, wherein the program images are sorted in the sub-window according to a basis.

5. The portable electronic device of claim 1, wherein the control unit is capable of controlling the portable electronic device to perform a first program relative to the first program image.

6. The portable electronic device of claim 5, wherein the display unit closes the sub-window in the frame when the portable electronic device performs the first program.

7. The portable electronic device of claim 1, wherein the program images are replaceable.

8. The portable electronic device of claim 1 further comprising an external input unit for the user to control a cursor in the frame.

9. The portable electronic device of claim 1, wherein each of the program images comprises a visual angle and the visual angle is adjustable.

10. The portable electronic device of claim 1, wherein the display unit displays a sub-menu frame relative to the first program image in the frame when the first program image overlaps the selecting section.

11. A program image selecting method, for quickly selecting a first program image by means of cooperating with a control unit and a hotkey of a portable electronic device, the program image selecting method comprising the following steps:
(A) a display unit of the portable electronic device displaying a sub-window in a frame when a user presses the hotkey, the sub-window comprising a selecting section and at least one program image; and
(B) operating the control unit to control the first program image of the program images to overlap the selecting section.

12. The program image selecting method of claim 11, wherein the step (B) is performed by the following step:
(B1) a touch unit sliding along a direction on an operation surface of the control unit to control the first program image to move to the selecting section.

13. The program image selecting method of claim 11, wherein the step (B) is performed by the following step:
(B2) a touch unit sliding along a direction on an operation surface of the control unit to control the selecting section to move to the first program image.

14. The program image selecting method of claim 11, wherein the program images are sorted in the sub-window according to a basis.

15. The program image selecting method of claim 11 further comprising the following step:
(C) controlling the portable electronic device to perform a first program relative to the first program image.

16. The program image selecting method of claim 15 further comprising the following step:
(D) the display unit closing the sub-windows in the frame when the portable electronic device performs the first program.

17. The program image selecting method of claim 11, wherein the program images are replaceable.

18. The program image selecting method of claim 11, wherein the portable electronic device is coupled to an external input unit, and the program image selecting method further comprises the following step:
(E) controlling a cursor in the frame by means of the external output unit when the frame displays the sub-window.

19. The program image selecting method of claim 11, wherein each of the program images comprises a visual angle and the visual angle is adjustable.

20. The program image selecting method of claim 11, wherein when the first program image overlaps the selecting section, the step (B) further comprises the following step:
(B3) the display unit displaying a sub-menu frame relative to the first program image in the frame.
